(19) United States
(12) Patent Application Publication
(10) Pub. No.: US 2014/0162691 A1
(43) Pub. Date: Jun. 12, 2014

(54) Positioning Method and Wireless Communication System Using the Same

(71) Applicant: Ralink Technology Corp., Hsinchu County (TW)

(72) Inventor: Min-Chung Wu, Taoyuan County (TW)

(73) Assignee: Ralink Technology Corp., Hsinchu County (TW)

(21) Appl. No.: 14/179,573

(22) Filed: Feb. 13, 2014

Related U.S. Application Data
(63) Continuation-in-part of application No. 13/040,276, filed on Mar. 4, 2011.
(60) Provisional application No. 61/382,922, filed on Sep. 15, 2010.
(60) Provisional application No. 61/422,660, filed on Dec. 14, 2010.
(60) Provisional application No. 61/425,252, filed on Dec. 21, 2010.

(51) Int. Cl. H04W 4/02

(52) U.S. Cl. CPC H04W 4/02
USPC 455/456.1

(57) ABSTRACT

A positioning method is disclosed. The positioning method includes providing a reference information comprising a plurality of predetermined RSSI values corresponding to a plurality of directional antennas receiving signals from a plurality of areas, utilizing the plurality of directional antennas to scan and detect a wireless communication device, calculating a plurality of RSSI values corresponding to the wireless communication device for the plurality of directional antennas, and determining a location position of the wireless communication device according to the reference information and the plurality of RSSI values.

### CROSS REFERENCE TO RELATED APPLICATIONS

This application is a Continuation-In-Part Application of U.S. patent application Ser. No. 13/040,276, which was filed on Mar. 4, 2011, and claimed the benefits of U.S. Provisional Application No. 61/382,922, filed on Sep. 15, 2010 and entitled “SMART ANTENNA AND SYSTEM USING THE SAME”, U.S. Provisional Application No. 61/422,660, filed on Dec. 14, 2010 and entitled “SMART ANTENNA SYSTEM”, and U.S. Provisional Application No. 61/425,252, filed on Dec. 21, 2010 and entitled “PORTABLE DEVICE WITH SMART ANTENNA”, the contents of which are all incorporated herein by reference.

### BACKGROUND OF THE INVENTION

1. Field of the Invention

The present invention relates to a positioning method and wireless communication system using the same, and more particularly, to a positioning method utilizing characteristics of directional antennas and wireless communication system using the same.

2. Description of the Prior Art

With the progression of information technology, portable devices, such as laptop notebooks, PDAs, tablets, smart phones, etc., have been integrated with more functions. These functions may include wireless local area network (WLAN), Bluetooth (BT), 3G communication, or global positioning system (GPS). A conventional portable device usually uses omni-antennas for transmitting and receiving radio signals.

A received signal strength indication (RSSI) value is often served as an effective gain of an antenna, and also an indication of how far the receiver is away from the signal source. However, even though the RSSI value can be used for determining the distance between the receiver and the signal source, the receiver can still not estimate the actual position of the signal source due to the unknown direction of the signal source. Therefore, development of techniques that can realize a positioning purpose should be a concern in progressive system design.

### SUMMARY OF THE INVENTION

It is therefore an object of the present invention to provide a positioning method and related wireless communication system.

The present invention discloses a positioning method including providing a reference information comprising a plurality of predetermined received signal strength indication (RSSI) values corresponding to a plurality of directional antennas receiving signals from a plurality of areas, utilizing the plurality of directional antennas to scan and detect a wireless communication device, calculating a plurality of RSSI values corresponding to the wireless communication device for the plurality of directional antennas and determining a location position of the wireless communication device according to the reference information and the plurality of RSSI values.

The present invention further discloses a wireless system. The wireless system includes a positioning device and a wireless communication device. The positioning device has a plurality of directional antennas. The positioning device establishes reference information corresponding to a plurality of areas, utilizes the plurality of directional antennas to scan and detect a wireless communication device, calculate a plurality of RSSI values corresponding to the wireless communication device for the plurality of directional antennas, and determines a location position of the wireless communication device according to the reference information and the plurality of RSSI values.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an embodiment of the present invention.

FIGS. 2A to 2C are schematic diagrams of antenna pattern of directional antenna according to an embodiment of the present invention.

FIG. 3 is a schematic diagram of a process according to an embodiment of the invention.

FIG. 4 is a schematic diagram of a predetermined map according to an embodiment of the invention.

FIG. 5 is a schematic diagram of a WLAN system according to an embodiment of the present invention.

FIG. 6 is a schematic diagram of a predetermined RSSI value corresponding to the directional antennas according to an embodiment of the present invention.

FIG. 7 is a schematic diagram of a radar map displaying the position result according to an embodiment of the present invention.

### DETAILED DESCRIPTION

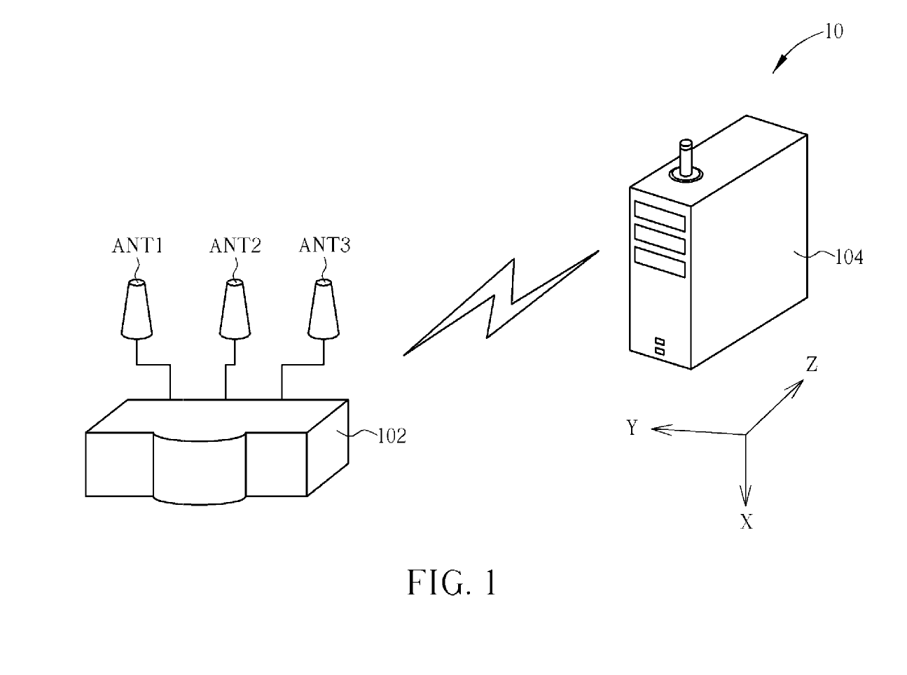

Please refer to FIG. 1, which is a schematic diagram of a wireless communication system 10 according to an embodiment of the present invention. The wireless communication system 10 includes a positioning device 102 and a wireless communication device 104. The wireless positioning device 102 includes directional antennas ANT1-ANT3 for transmitting and receiving signal. Preferably, the directional antennas ANT1-ANT3 are configured to direct toward different directions respectively. The wireless positioning device 102 is capable of using the directional antennas ANT1-ANT3 to scan and detect the wireless communication device 104, and therefore, decide the location of the wireless communication device 104 accordingly.

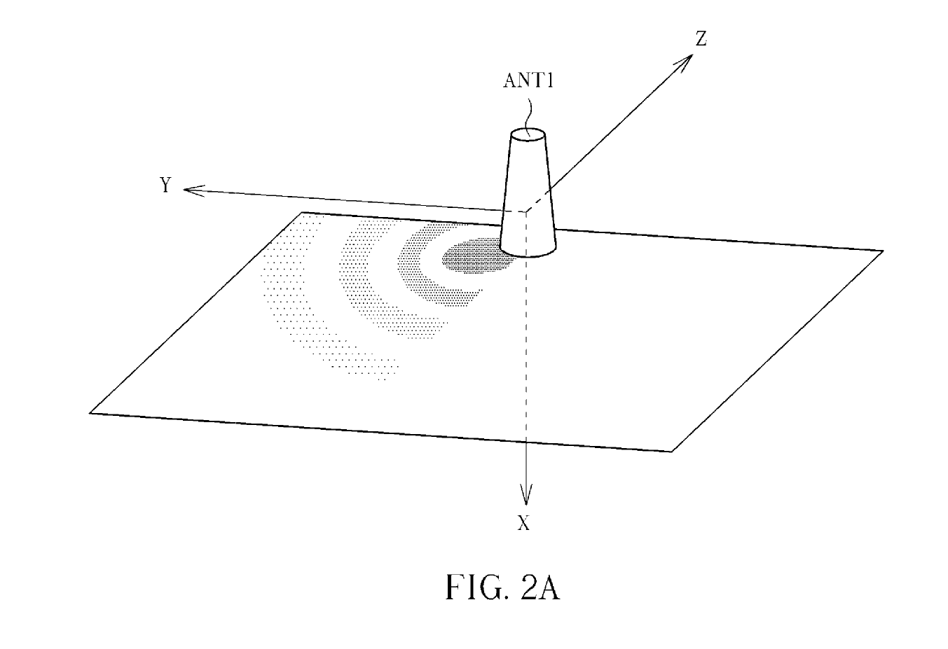

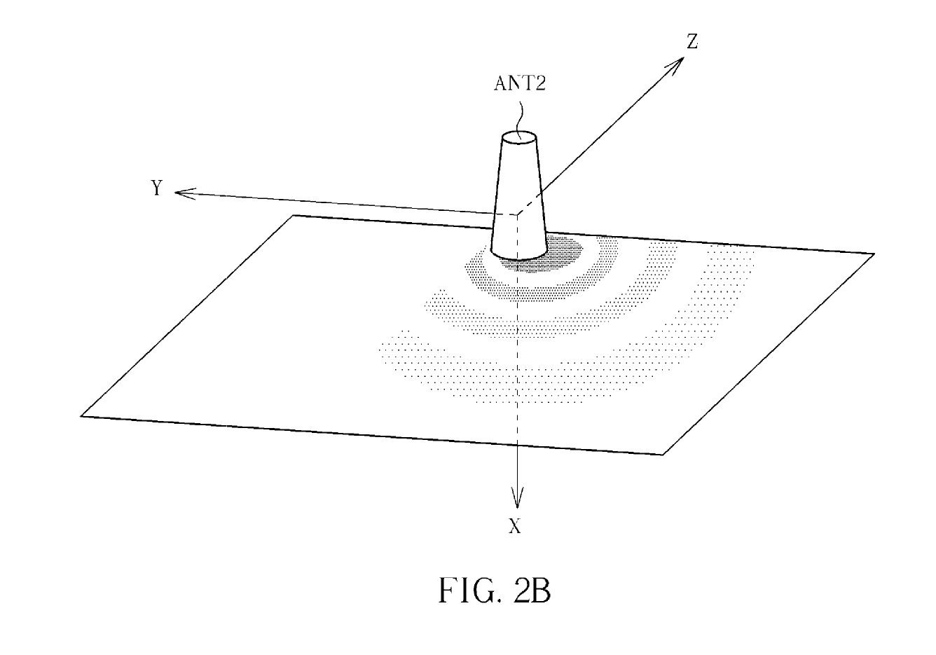

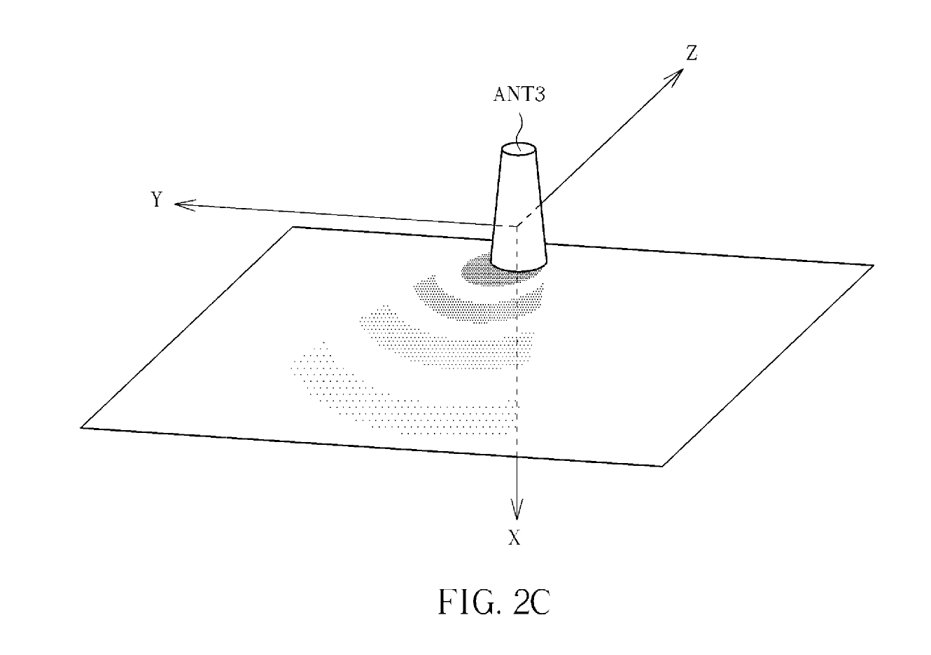

A directional antenna is an antenna which radiates higher power in one or more specific directions allowing for increased performance. The directional antenna has many advantages in a corresponding directional radiation pattern, such as high gain for desired signal, long transmission distance, better RSSI, low side lobe for interference, and low noise floor. In other words, the directional antenna is capable of concentrating the coverage pattern in one or more specific directions. This produces an almost conical-shaped coverage pattern (like a flashlight). Besides, the directionality of the directional antenna is specified by the angle of the beam width, which is from 90 degrees, to as little as 20 degrees. Please refer to FIG. 2A to FIG. 2C, the directional antenna ANTI is directed toward +Y-axis and the radiation pattern of the directional antennas antenna ANTI can be represented in FIG. 2A. The directional antenna ANT2 and the directional antenna ANT3 are respectively directed toward −Y-axis and −z-axis, and the corresponding radiation patterns are represented in FIG. 2B and FIG. 2C respectively. In such a condition, as the wireless communication device 104 is located at a position P, there are different RSSI values measured by the directional antennas ANT1-ANT3. The RSSI value measured by the directional antenna ANT2 will be far larger than that measured by the antennas ANTI and ANT3. As a result, in a two-dimensional space, each wireless communication device located at various positions will have a unique RSSI value combination corresponding to the antennas ANT1-ANT3.

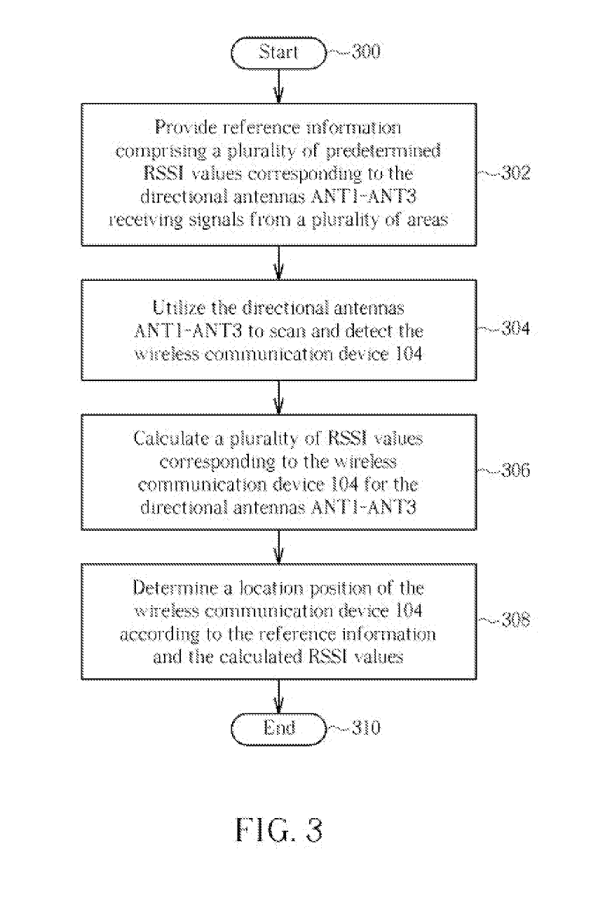

Operations of the wireless communication system 10 can be summarized into a positioning process 30 as shown in FIG. 3. Note that the following steps are not limited to be performed according to the exact sequence shown in FIG. 3 if a roughly identical result can be obtained. The positioning process 30 includes, but is not limited to, the following steps:

Step 300: Start.

Step 302: Provide reference information comprising a plurality of predetermined RSSI values corresponding to the directional antennas ANT1-ANT3 receiving signals from a plurality of areas.

Step 304: Utilize the directional antennas ANT1-ANT3 to scan and detect the wireless communication device 104.

Step 306: Calculate a plurality of RSSI values corresponding to the wireless communication device 104 for the directional antennas ANT1-ANT3.

Step 308: Determine a location position of the wireless communication device 104 according to the reference information and the calculated RSSI values.

Step 310: End.

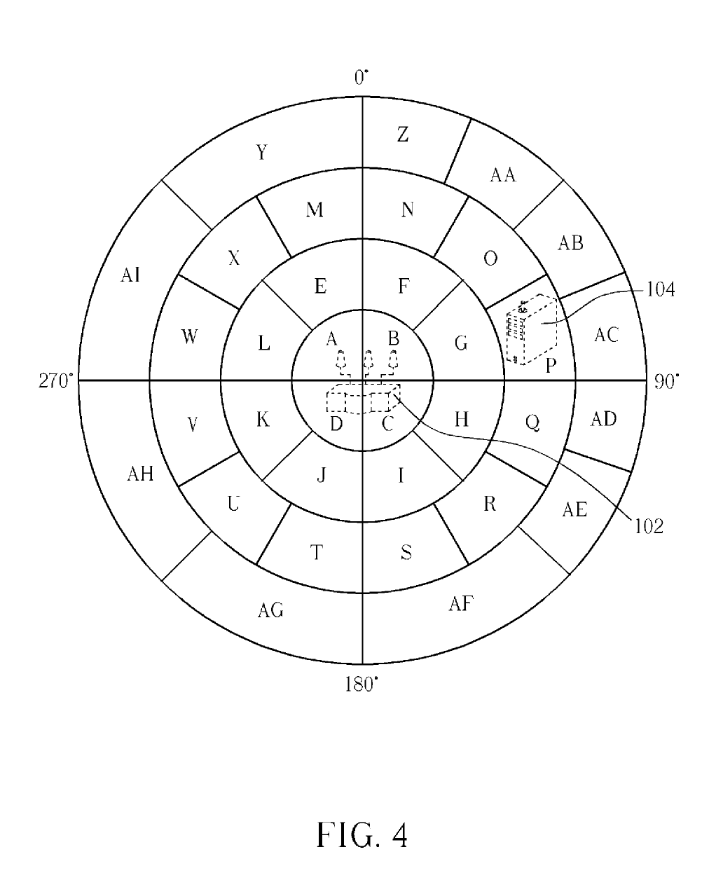

Further description associated with the positioning process 30 follows. Please refer to FIG. 4, which is a schematic diagram of a predetermined map according to an embodiment of the invention. Suppose the coverage range of the directional antennas ANT1-ANT3 is divided into areas A to AI as shown in FIG. 4 and the positioning device 102 is located on the center of the predetermined map.

First, in Step 302, the positioning device 102 is able to establish the reference information for the following process. The reference information includes a plurality of predetermined RSSI values corresponding to the directional antennas ANT1-ANT3 during receiving signals from the areas A to AI. For example, if each of the areas A to AI has one test wireless communication device, the positioning device 102 can utilize each directional antenna to detect and calculate its corresponding RSSI value with every test wireless communication device. In detail, the positioning device 102 can respectively utilize the directional antennas ANT1-ANT3 to scan and communicate with each test wireless communication devices in the areas A to AI. Accordingly, the positioning device 102 can calculate the corresponding RSSI values and record the corresponding RSSI values. Moreover, the calculated RSSI values for the directional antennas ANT1-ANT3 can be used as the predetermined RSSI values, and the positioning device 102 can further determine all the predetermined RSSI values to be the reference information. In other words, for every area, each of the directional antennas ANT1-ANT3 has a corresponding predetermined RSSI value.

Furthermore, in Step 304, when a user intends to find the location of the wireless communication device 104, the positioning device 102 can utilize the directional antennas ANT1-ANT3 to scan and detect the wireless communication device 104.

After that, in Step 306, the positioning device 102 calculates RSSI values RSSI_{—}1 to RSSI_{—}3 corresponding to the wireless communication device 104 for the directional antennas ANT1-ANT3. For example, the positioning device 102 can calculate the RSSI value RSSI_1 for the directional antennas ANT1 during the directional antenna ANTI receiving signals from the wireless communication device 104, calculate the RSSI value RSSI_{—}2 for the directional antenna ANT2 during the directional antennas ANT2 receiving signals from the wireless communication device 104, and so on. In other words, the corresponding RSSI values between each directional antenna and the wireless communication device 104 can be obtained in Step 306.

Therefore, in Step 308, the positioning device 102 can determine a location position of the wireless communication device 104 according to the reference information and the calculated RSSI values. When it indicates that each of the detected RSSI values falls into the range of the predetermined RSSI values of the corresponding directional antenna receiving signals from a specific area, the positioning device 102 determines the specific area to be the location position. For example, if the calculated RSSI value RSSI_{—}1 falls into the range of the predetermined RSSI values of the directional antenna ANT1 of the area P, the calculated RSSI value RSSI_{—}2 falls into the range of the predetermined RSSI values of the directional antenna ANT2 of the area P, and the calculated RSSI value RSSI_{—}3 falls into the range of the predetermined RSSI values of the directional antenna ANT3 of the area P, then the positioning device 102 can determine the area P is the location position of the wireless communication device 104. Therefore, through obtaining the corresponding RSSI value of each directional antenna, the user can quickly and accurately recognize the location position on the predetermined map of the wireless communication device 104.

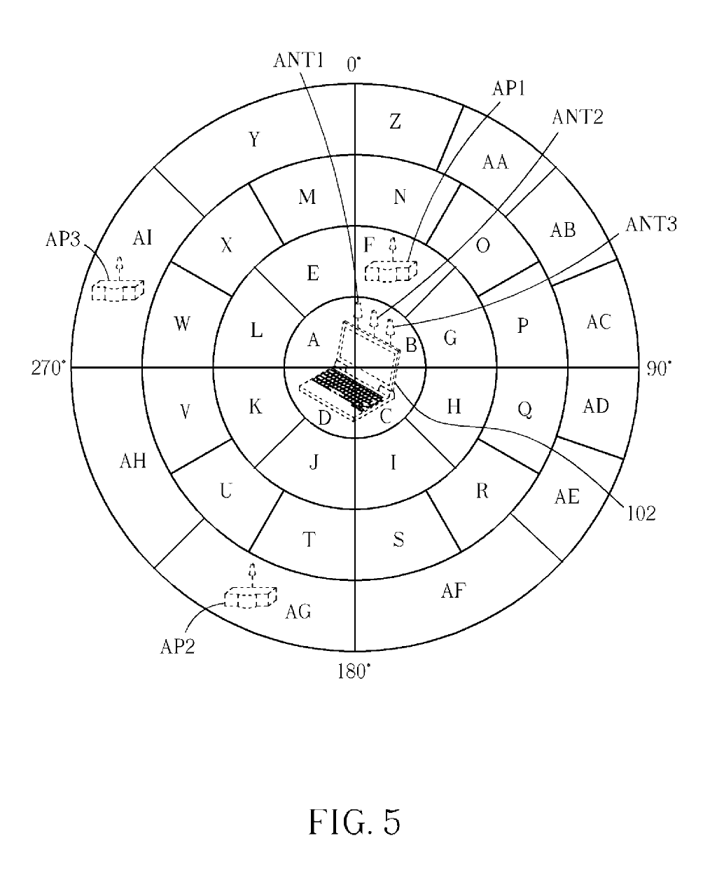

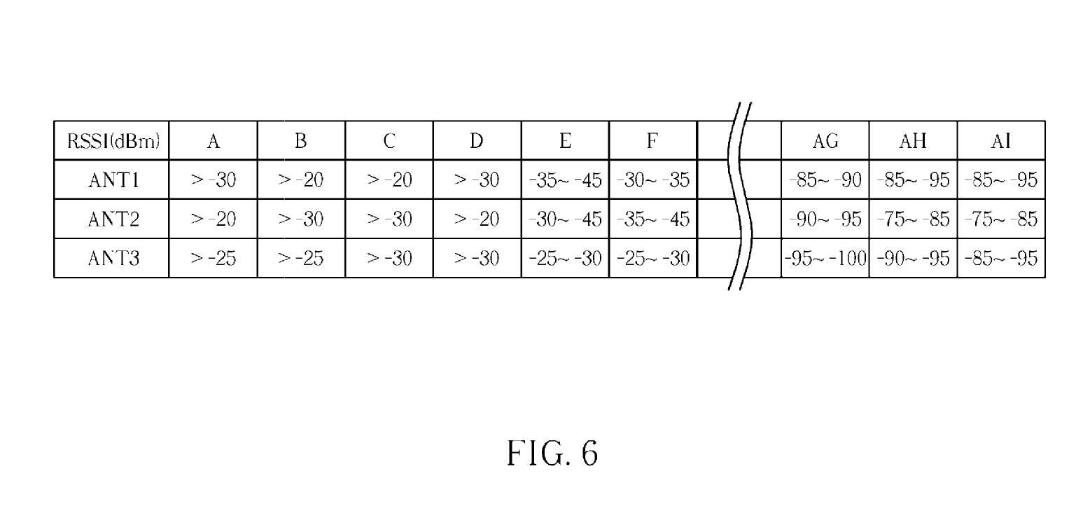

Take a wireless local area network (WLAN) system as an example, please refer to FIG. 5, which is a schematic diagram of a WLAN system 50 according to an embodiment of the present invention. The WLAN system 50 includes a notebook 502 having directional antennas ANT1-ANT3 and access points AP1-AP3. In the WLAN system 50, the notebook 502 can only access to the access points AP1-AP3 by the directional antennas ANT1-ANT3 within the coverage range of the directional antennas ANT1-ANT3. First, the notebook 502 calculates the corresponding predetermined RSSI values corresponding to the directional antennas ANT1-ANT3 during receiving signals from the areas A to AI (Step 302). Please refer to FIG. 6, which is a schematic diagram of a predetermined RSSI value corresponding to the directional antennas ANT1-ANT3 according to an embodiment of the present invention. When a user intends to surf Internet, and likes to know which access point is available within the coverage range of the directional antennas ANT1-ANT3 and where the available access point is located on the predetermined map, the user can operate the notebook 502 to utilize the directional antennas ANT1-ANT3 to scan and communicate with each available access points (Step 304). After that, the notebook 502 calculates RSSI values RSSI1_{—}1 to RSSI1_{—}3, RSSI2_{—}1 to RSSI2_{—}3, and RSSI3_{—}1 to RSSI3_{—}3. The RSSI values RSSI1_{—}1 to RSSI1_{—}3 are presented RSSI values between the directional antenna ANTI and the access points AP1-AP3 respectively (Step 306). The RSSI values RSSI2_{—}1 to RSSI2_{—}3 are presented RSSI values between the directional antenna ANT2 and the access points AP1-AP3 respectively. The RSSI values RSSI3_{—}1 to RSSI3_{—}3 are presented RSSI values between the directional antenna ANT3 and the access points AP1-AP3 respectively. If the RSSI values RSSI1_{—}1, RSSI2_{—}1, and RSSI3_{—}1 are respectively −33 dBm, −37 dBm, and −28 dBm, the notebook 502 can determine access point AP1 is at the area F accordingly. Also, if the RSSI values RSSI1_{—}2, RSSI2_{—}2, and RSSI3_{—}2 are respectively −86 dBm, −93 dBm, and −99 dBm, the notebook 502 can determine access point AP2 is at the area AG accordingly. Such like this, the notebook 502 can determine access point AP3 is at the area AI accordingly.

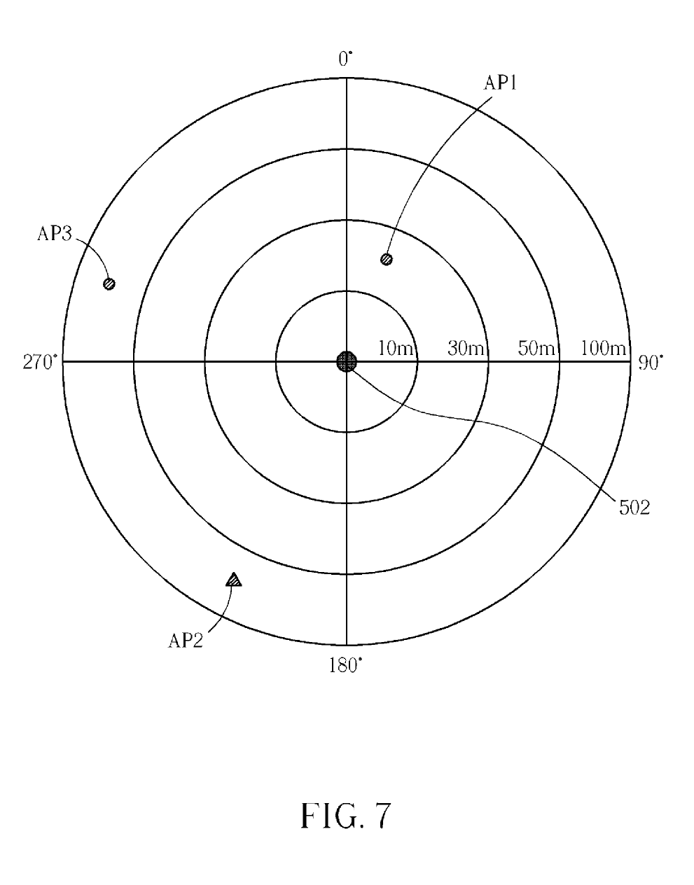

In addition, the notebook 502 can display the location determination result of the access points AP1-AP3 on the display device. For example, please refer to FIG. 7, the location determination result of the access points AP1-AP3 can be displayed with a radar map manner for indicating the access points AP1-AP3.

In summary, since the conventional wireless communication system uses omni-antennas to calculate the distance between the receiver and the signal source, the invention can offer a position method by utilizing directional antennas for realizing two-dimensional positioning purposes rapidly and accurately.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A positioning method, comprising:
providing a reference information comprising a plurality of predetermined received signal strength indication (RSSI) values corresponding to a plurality of directional antennas receiving signals from a plurality of areas;
utilizing the plurality of directional antennas to scan and detect a wireless communication device;
calculating a plurality of RSSI values corresponding to the wireless communication device for the plurality of directional antennas; and
determining a location position of the wireless communication device according to the reference information and the plurality of RSSI values.

2. The positioning method of claim 1, wherein the step of providing the reference information comprising the plurality of predetermined RSSI values corresponding to the plurality of directional antennas receiving signals from a plurality of areas comprising:
for each of the plurality of directional antenna, detecting and calculating a corresponding RSSI value for defining the predetermined RSSI values during reception of signals from one of the plurality of areas; and
determining all of the predetermined RSSI values calculated for the plurality of areas to be the reference information.

3. The positioning method of claim 1, wherein the step of calculating the plurality of RSSI values corresponding to the wireless communication device for the plurality of directional antennas comprises respectively calculating a corresponding RSSI value for each of the plurality of directional antennas during reception of signals from the wireless communication device.

4. The positioning method of claim 1, wherein the step of determining the location position of the wireless communication device according to the reference information and the plurality of RSSI values comprises when each of the detected RSSI values falls into the range of the predetermined RSSI values of the corresponding directional antenna receiving signals from a specific area, determining the specific area to be the location position.

5. The positioning method of claim 1, wherein each of the plurality of detected RSSI values is a RSSI value of one of the plurality of directional antennas during reception of signals from the wireless communication device.

6. The positioning method of claim 1, wherein the plurality of directional antennas are configured toward different directions.

7. A wireless system, comprising:
a positioning device having a plurality of directional antennas; and
a wireless communication device;
wherein the positioning device establishes reference information corresponding to a plurality of areas, utilizes the plurality of directional antennas to scan and detect a wireless communication device, calculates a plurality of received signal strength indication (RSSI) values corresponding to the wireless communication device for the plurality of directional antennas, and determines a location position of the wireless communication device according to the reference information and the plurality of RSSI values.

8. The wireless system of claim 7, wherein the reference information comprises a plurality of predetermined RSSI values corresponding to the plurality of directional antennas receiving signals from the plurality of areas.

9. The wireless system of claim 7, wherein the positioning device detects and calculates a corresponding RSSI value for defining the predetermined RSSI values during reception of signals from one of the plurality of areas for each of the plurality of directional antenna, and determines all of the predetermined RSSI values calculated for the plurality of areas to be the reference information.

10. The wireless system of claim 8, wherein the positioning device respectively calculates a corresponding RSSI value for each of the plurality of directional antennas during reception of signals from the wireless communication device.

11. The wireless system of claim 10, wherein when each of the detected RSSI values falls into the range of the predetermined RSSI values of the corresponding directional antenna receiving signals from a specific area, the positioning device determines the specific area to be the location position.

12. The wireless system of claim 7, wherein each of the plurality of detected RSSI values is a RSSI value of one of the plurality of directional antennas during reception of signals from the wireless communication device.

13. The wireless system of claim 7, wherein the plurality of directional antennas are configured toward different directions.
